(19) United States
(12) Patent Application Publication
(10) Pub. No.: US 2012/0280427 A1
(43) Pub. Date: Nov. 8, 2012

(54) METHOD AND DEVICE FOR PRODUCING COILS FROM WIRES

(75) Inventors: Wolfgang Bachmann, Otzberg (DE); Marcel Julien, Roedermark (DE); Pascal Julien, Rodgau (DE)

(73) Assignee: KARL MAYER TEXTILMASCHINENFABRIK GMBH, Obertshausen (DE)

(21) Appl. No.: 13/519,511

(22) PCT Filed: Dec. 10, 2010
(86) PCT No.: PCT/EP10/07547

§ 371 Date: Jun. 27, 2012

(30) Foreign Application Priority Data
Dec. 30, 2009 (DE) 10 2009 060 743.9

(51) Int. Cl. B29C 53/32; B21D 31/00; B21F 45/00

(52) U.S. Cl. 264/281; 425/319; 425/174.4; 264/482; 140/71 C; 72/364

(57) ABSTRACT

The invention relates to a method and a device for producing coils (9) with longitudinal sections (9a) and narrow deflection bends (9b) by winding wires (8) on winding mandrels (4) with complementary cross sections with the supply of heating energy and subsequent fixing by cooling. To attain the object to rule out the spring rebounds of the coils (9) at the points of narrowest radii of curvature as far as possible and to produce coils (9) with high precision with high efficiency, it is proposed according to the invention that the heating energy is brought to act on the coils (9) at least mainly in the region of the narrow deflection bends (9b). This can be carried out by the targeted application of heating gases or hot air, laser radiation, contact heating, plasma radiation and ultrasound.

The invention relates to methods for producing coils with longitudinal sections and narrow deflection bends by winding wires on winding mandrels with complementary cross sections with the supply of heating energy and subsequent fixing by cooling.

Methods of this type and the devices provided for them, as known, are used for producing primary products for further processing to form coil screens, filter fabrics, transport belts and even for zippers if the coils are provided with toothings.

A method and a device are known from DE 34 21 849 C2, by which coils of thermoplastic wires or monofilaments are produced with oval or race-track-like coat surfaces. This takes place by winding the wires on stationary elongated winding mandrels with surfaces complementary to the coil form, which are arranged between two heating devices. These heating devices are infrared radiators and are located on both sides of the largest cross-sectional plane of the winding mandrel so that the circumferences of the coils with the smallest radii of curvature are heated least.

Due to residual stresses from the memory effect of the plastics, this leads to spring rebounds of the coils so that the longitudinal axis thereof, after drawing off or sliding off the winding mandrel, adopts a marked three-dimensional wave form. This in turn prevents the flat bearing on a working surface and the axial insertion of connecting wires or pintle wires in order, for example, to produce the above-mentioned flat structures from coils of this type.

Since the coils are wound prestressed around the winding mandrels, primarily in the two deflection bends in each case a stress distribution between tensile stress and compressive stress develops, which with an incomplete alignment of the molecules by heating close to the softening point tends to cause a reconversion of the monofilament into its starting shape, which is referred to as the memory effect. However if a reconversion of this type occurs even to a small extent, the product becomes unusable. However, this memory effect does not occur on the long sides of the cross section, since these were not deformed during winding, so that they do not contribute to the reconversion of the coils.

A general increase in the heating capacity, e.g., in large-volume heating chambers, with the known arrangements would mean that also the straight or less curved circumferential sections of the wires, the so-called “long sides,” shrink up to 25%, which in turn would lead to a blocking on the winding mandrel and to a stoppage of production. However, this could be combatted only to a very limited extent by a more marked and uniform tapering of the winding mandrel.

Due to these circumstances, the known methods and devices can be used only in the range of low operating speeds with low thermal efficiency and with high waste rates.

The object of the invention is therefore to disclose a method and a device through which spring rebounds of the coils at the points of narrowest radii of curvature are ruled out as far as possible and by which coils with high precision can be produced with high efficiency.

The object is attained with the method disclosed at the outset according to the invention in that the heating energy is brought to act on the coils at least mainly in the region of the narrow deflection bends.

However, not only is the given object is attained thereby, namely the spring rebounds of the coils at the points of narrowest radii of curvature are ruled out as far as possible, but coils are also produced with high precision with high efficiency. For example, in the production of coils for the production of paper machine clothings or of transport belts the memory effects are reduced in the deflection bends and avoided in the straight connection lengths. Thereby in a matter of seconds the stresses built up by winding are eliminated in the monofilaments, the molecules are relaxed and by immediate cooling set in a stress-free manner and the coils permanently fixed in the ideal shape. It is furthermore ensured thereby that no shrink forces or only very low shrink forces act on the long sides, whereby the coils could shrink firmly onto the winding mandrels. Preheating times and slow production speeds as well as waste of more than e.g. 5% and energy waste are avoided and high dimensional accuracies—even with the end products—are achieved with low stoppage times. To put it simply therefore, the invention is composed of a concentration of the heating on the points of greatest curvatures.

In the course of further embodiments of the method it is particularly advantageous if either individually or in combination:
The action of the heating energy on the wires is suppressed outside the deflection bends,
The heating energy is brought to act on the deflection bends in a targeted manner by means of heating gas through nozzles,
The heating energy is brought to act on the deflection bends in a targeted manner by means of laser radiation,
The heating energy is brought to act on the deflection bends (9b) in a targeted manner by means of contact heating,
The heating energy is brought to act on the deflection bends in a targeted manner by means of plasma radiation,
The heating energy is brought to act on the deflection bends (9b) in a targeted manner by means of ultrasound,
The action of the heating energy in the region of the longitudinal sections of the coils is suppressed by guide bodies.

The invention also relates to a device for producing coils with elongated cross sections and narrow deflection bends by winding wires on winding mandrels with complementary cross sections and with means for the supply of heating energy and with downstream means for fixing by cooling, wherein the winding mandrels have a largest cross-sectional plane that is arranged in the region of the narrow deflection bends.

To attain the same object and to achieve the same advantages, the device is characterized in that the means for the targeted supply of heating energy are arranged in the direction of the cross-sectional plane.

In the course of further embodiments of the device it is particularly advantageous if either individually or in combination:
Guide bodies for suppressing the action of the heating energy on the wires are arranged on opposite sides of the cross-sectional plane,
For the supply of heating energy, nozzles are arranged for the supply of heating gases in the direction parallel to the cross-sectional plane,
For the supply of heating energy, laser beam sources are arranged with a beam direction parallel to the cross-sectional plane,
For the supply of heating energy, ultrasound sources are arranged with a beam direction parallel to the cross-sectional plane,
For the supply of heating energy, plasma beam sources are arranged with the beam direction parallel to the cross-sectional plane,
For the supply of heating energy, electrically heated banks of contacts are arranged, which are penetrated by the cross-sectional plane, and/or if
For the suppression of the action of the heating energy on the coils in the region of the longitudinal sections thereof on both sides of the cross-sectional plane, guide bodies are arranged for the deflection of heating gases.

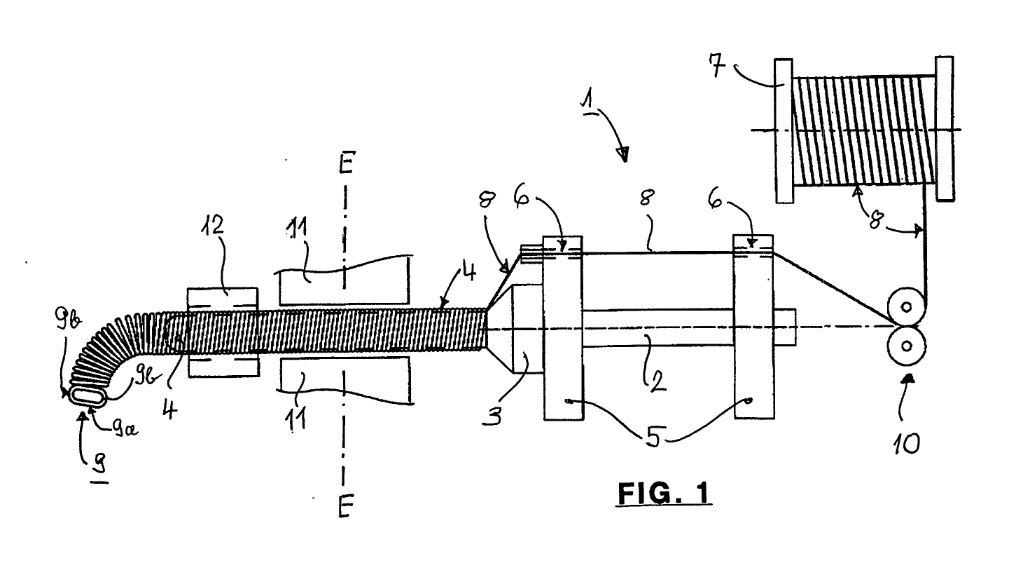

Exemplary embodiments of the subject matter of the invention and the modes of operation thereof and further advantages are explained in further detail below based on the diagrammatic FIGS. 1 through 7.

They show:

FIG. 1 a plan view of the functionally essential parts of the winding and heating device,

FIG. 2 a cross section through a winding mandrel with coil in the region of a heating by hot air,

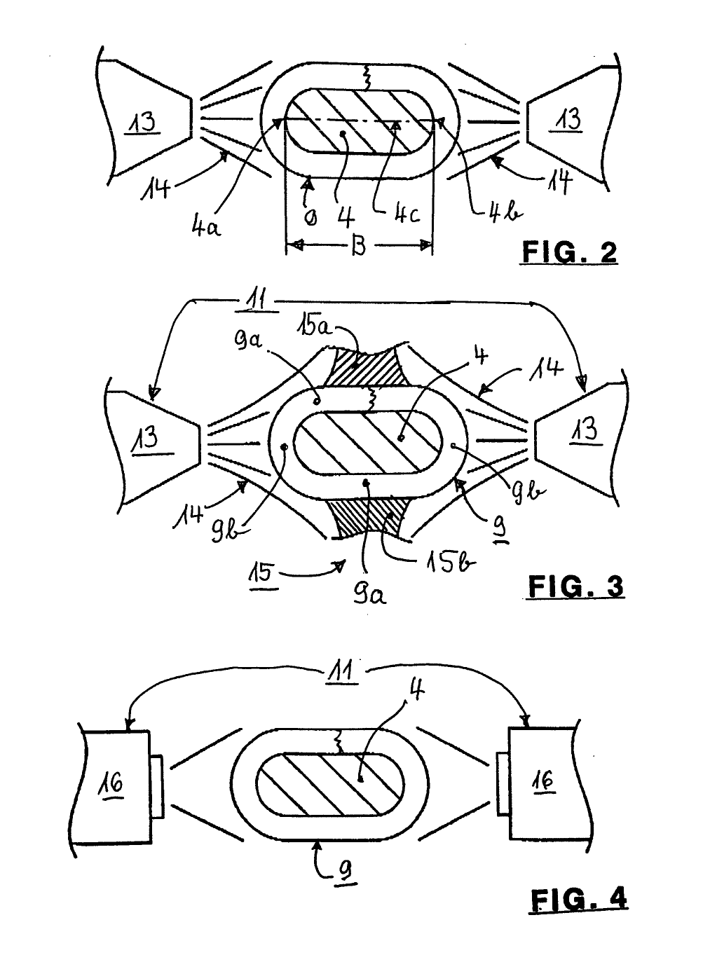

FIG. 3 a cross section through a winding mandrel with coil in the region of a heating by hot air and with an additional air conduction system,

FIG. 4 a cross section through a winding mandrel with coil in the region of a heating by laser beams,

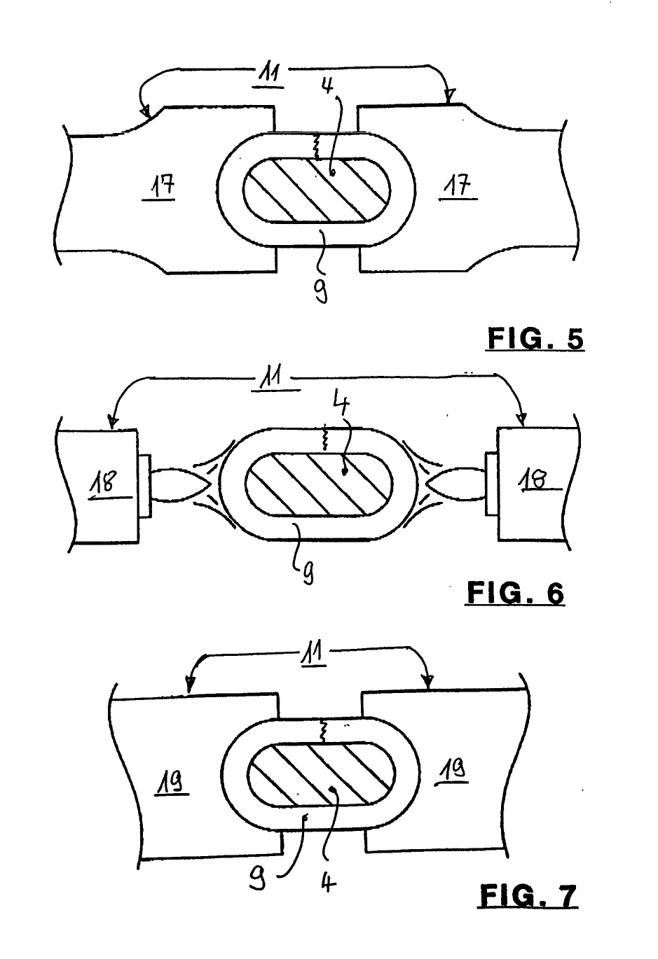

FIG. 5 a cross section through a winding mandrel with coil in the region of a heating by ultrasound,

FIG. 6 a cross section through a winding mandrel with coil in the region of a heating by plasma beams and

FIG. 7 a cross section through a winding mandrel with coil in the region of a heating by banks of contacts.

FIG. 1 shows a winding device 1 which has a non-rotating shaft 2 with a clamping device 3, in which a winding mandrel 4 is clamped in a replaceable manner, the outlines of which are shown merely by broken lines here. This winding mandrel 4, to put it in a simplified manner, has the shape of a sword, the rounded longitudinal edges of which taper slightly towards the free end.

On the shaft 2, two guide disks 5 are supported by means of antifriction bearings, not shown, but in a rotationally fixed manner to one another, which guide disks in their edge regions each has a guide bore 6, the longitudinal axes of which are aligned with one another. The device has a replaceable delivery drum 7 with a wound wire 8, a so-called monofilament, from which the specially shaped coil 9 is to be produced. The wire 8 is made of a plastic or metal that is plastically deformable at a substance-specific temperature, but thereafter can be fixed in the deformed state by cooling. The wire 8 is guided through guide rolls 10 before entering the guide disks 5, the nip of which guide rolls surrounds the common rotation axis of the guide disks 5.

After the winding on the winding mandrel 4, the coil 9 first runs through a two-part heating device 11, which is aligned to the round edges 4a and 4b, lying opposite, of the winding mandrel 4. Different exemplary embodiments of such heating devices are discussed in more detail below based on FIGS. 2 through 7, which show perpendicular cross sections along the plane E-E. The heating device 11 is followed at a distance by a cooling device 12, which can be operated by compressed air. The convergence of the rounded longitudinal edges of the winding mandrel 4 is to be selected thereby such that the possibility of the coil 9 shrinking on is ruled out. The result is shown at the left end of FIG. 1: a coil 9 with straight longitudinal sections 9a and narrow deflection bends 9b.

FIG. 2 shows a cross section through a winding mandrel 4 in the plane E-E according to FIG. 1 with a plan view on a winding of the coil 9. The winding mandrel 4 has in the direction of its longitudinal axis, which runs perpendicular to the drawing plane, a largest cross-sectional plane 4c, which is shown by dashed lines and ends with a width B at the round edges 4a and 4b. This also applies to the other figures. The heating device 11 in this case is composed of two nozzles 13, the gap-shaped openings of which run parallel to the round edges 4a and 4b. The nozzles 13 direct hot air jets 14 onto the coil 9 in the regions of its greatest curves at the round edges 4a and 4b. It is important thereby that the heating is carried out by means of hot air with high temperature, energy density and speed in order to produce an effective heat transfer.

It should further be noted here, also with respect to FIG. 1, that the spatial position of the device can be selected as desired. Thus, e.g., the position of the cross-sectional plane 4c of the winding mandrel 4 can be selected to be horizontal as well as vertical, provided that the active direction of the heating devices 11 is maintained on the round edges 4b or the deflection bends 9b of the coil 9.

FIG. 3 shows a further development of the subject matter of FIG. 2. Here an air conducting system 15 for the hot air is assigned to the long sides of the coil 9 with the smallest possible spaces in the region of the heating device 11, which heat conducting system is composed of two guide bodies 15a and 15b harmoniously shaped with respect to the flows.

With the subject matter of FIG. 4, the heating device 11 with analogous spatial positions is composed of two laser beam sources 16. With the subject matter of FIG. 5, the heating device 11 with analogous spatial positions is composed of two ultrasound sources 17. With the subject matter of FIG. 6, the heating device 11 with analogous spatial positions is composed of two plasma beam sources 18. And with the subject matter of FIG. 7, the heating device 11 with analogous spatial positions is composed of two electrically heated banks of contacts 19. Such heating devices are known per se—for other purposes—and can be obtained including their sources for supply with heating energy from specialist companies.

### LIST OF REFERENCE NUMBERS

1 Winding device
2 Shaft
3 Clamping device
4 Winding mandrel
4a Round edge
4b Round edge
4c Cross-sectional plane
5 Guide disks
6 Guide bores
7 Delivery drum
8 Wire (monofilament)
9 Coil
9a Longitudinal sections
9b Deflection bends
10 Guide rolls
11 Heating device
12 Cooling device
13 Nozzles
14 Hot air jets
15 Air conduction system
15a Guide body
15b Guide body
16 Laser beam sources
17 Ultrasound sources
18 Plasma beam sources
19 Banks of contacts
B Width
E-E Plane

1. A method for producing coils (9) with longitudinal sections (9a) and narrow deflection bends (9b) by winding wires (8) on winding mandrels (4) with complementary cross sections with the supply of heating energy and subsequent fixing by cooling, characterized in that the heating energy is brought to act on the coils (9) at least mainly in the region of the narrow deflection bends (9b).

2. The method according to claim 1, characterized in that the action of the heating energy on the wires (8) is suppressed outside the deflection bends (9b).

3. The method according to claim 1, characterized in that the heating energy is brought to act on the deflection bends (9b) in a targeted manner by means of heating gas through nozzles (13).

4. The method according to claim 1, characterized in that the heating energy is brought to act on the deflection bends (9b) in a targeted manner by means of laser radiation.

5. The method according to claim 1, characterized in that the heating energy is brought to act on the deflection bends (9b) in a targeted manner by means of contact heating.

6. The method according to claim 1, characterized in that the heating energy is brought to act on the deflection bends (9b) in a targeted manner by means of plasma radiation.

7. The method according to claim 1, characterized in that the heating energy is brought to act on the deflection bends (9b) in a targeted manner by means of ultrasound.

8. The method according to claim 2, characterized in that the action of the heating energy in the region of the longitudinal sections (9a) of the coils (9) is suppressed by guide bodies (15a, 15b).

9. A device for producing coils (9) with elongated cross sections and narrow deflection bends (9a) by winding wires (8) on winding mandrels (4) with complementary cross sections and with means for the supply of heating energy and with downstream means for fixing by cooling, wherein the winding mandrels (4) have a largest cross-sectional plane (E-E) that is arranged in the region of the narrow deflection bends (9b), characterized in that the means for the targeted supply of heating energy are arranged in the direction of the cross-sectional plane (E-E).

10. The device according to claim 9, characterized in that guide bodies (15a, 15b) for suppressing the action of the heating energy on the wires (8) are arranged on opposite sides of the cross-sectional plane (E-E).

11. The device according to claim 9, characterized in that for the supply of heating energy, nozzles (13) are arranged for the supply of heating gases in the direction parallel to the cross-sectional plane (E-E).

12. The device according to claim 9, characterized in that for the supply of the heating energy, laser beam sources (16) are arranged with a beam direction parallel to the cross-sectional plane (E-E).

13. The device according to claim 9, characterized in that for the supply of the heating energy, ultrasound sources (17) are arranged with a beam direction parallel to the cross-sectional plane (E-E).

14. The device according to claim 9, characterized in that for the supply of the heating energy, plasma beam sources (18) are arranged with the beam direction parallel to the cross-sectional plane (E-E).

15. The device according to claim 9, characterized in that for the supply of heating energy, electrically heated banks of contacts (19) are arranged, which are penetrated by the cross-sectional plane (E-E).

16. The device according to claim 9, characterized in that for the suppression of the action of the heating energy on the coils (9) in the region of the longitudinal sections (9a) thereof on both sides of the cross-sectional plane (E-E), guide bodies (15a, 15b) are arranged for the deflection of heating gases.
